(19) United States
(12) Patent Application Publication
(10) Pub. No.: US 2008/0271121 A1
(43) Pub. Date: Oct. 30, 2008

(54) EXTERNAL USER LIFECYCLE MANAGEMENT FOR FEDERATED ENVIRONMENTS

(76) Inventors: Heather Maria Hinton, Austin, TX (US); Patrick Ryan Wardrop, Austin, TX (US); Anthony Scott Moran, Fort Lauderdale, FL (US)

Correspondence Address: IBM CORP. (DHJ);c/o DAVID H. JUDSON, 15950 DALLAS PARKWAY, SUITE 225, DALLAS, TX, 75248, US

(21) Appl. No.: 11/740,956

(22) Filed: Apr. 27, 2007

(51) Int. Cl. H04L 9/32

(52) U.S. Cl. 726/4

(57) ABSTRACT

The present invention provides a generic technique that externalizes the management of a user session, particularly in the context of a federated environment. The invention obviates any requirement to design and implement special software (or any requirement to modify a previously installed plug-in) to enable third party SSOp-aware applications to manage the lifecycle of a user session. In an illustrative embodiment, the user session lifecycle is managed externally through an external authentication interface (EAI) that has been extended to enable any POC (or SSOp-aware application) to interface to a federated identity provider component using a simple HTTP transport mechanism. In the inventive approach, HTTP request and response headers carry the information that is used by the POC to initiate and later destroy a user session, and such information is provided by a federated entity without requiring use of a special authentication API.

### BACKGROUND OF THE INVENTION

1. Technical Field

The present invention relates generally to management of user sessions in a federated environment.

2. Background of the Related Art

Federated environments are well known in the art. U.S. Publication No. 2006/0021018, filed Jul. 21, 2004, is representative. A federation is a set of distinct entities, such as enterprises, organizations, institutions, or the like, that cooperate to provide a single-sign-on, ease-of-use experience to a user; a federated environment differs from a typical single-sign-on environment in that two enterprises need not have a direct, pre-established, relationship defining how and what information to transfer about a user. Within a federated environment, entities provide services that deal with authenticating users, accepting authentication assertions (e.g., authentication tokens) that are presented by other entities, and providing some form of translation of the identity of the vouched-for user into one that is understood within the local entity. Federation eases the administrative burden on service providers. A service provider can rely on its trust relationships with respect to the federation as a whole; the service provider does not need to manage authentication information, such as user password information, because it can rely on authentication that is accomplished by a user's authentication home domain or an identity provider.

A federated entity may act as a user's home domain, which provides identity information and attribute information about federated users. An entity within a federated computing environment that provides identity information, identity or authentication assertions, or identity services is termed an identity provider. Other entities or federation partners within the same federation may rely on an identity provider for primary management of a user's authentication credentials, e.g., accepting a single-sign-on token that is provided by the user's identity provider; a domain at which the user authenticates may be termed the user's (authentication) home domain. An identity provider is a specific type of service that provides identity information as a service to other entities within a federated computing environment. With respect to most federated transactions, an issuing party for an authentication assertion would usually be an identity provider; any other entity can be distinguished from the identity provider. Any other entity that provides a service within the federated computing environment can be categorized as a service provider. Once a user has authenticated to the identity provider, other entities or enterprises in the federation may be regarded as merely service providers for the duration of a given federated session or a given federated transaction.

With reference now to FIG. 1, a block diagram depicts the terminology of the federated environment with respect to a transaction that is initiated by a user to a first federated enterprise, which, in response, invokes actions at downstream entities within the federated environment. FIG. 1 illustrates that the federated environment supports transitivity of trust and transitivity of an authentication assertion process; in particular, a given domain can issue an assertion based on its trust in an identity as asserted by another domain. In this example, User 102 initiates a transaction through a request for a protected resource at enterprise 104. If user 102 has been or will be authenticated by enterprise 104 during the course of a transaction, then enterprise 104 is the user's home domain, i.e. the user's identity provider, for this federated session. Assuming the transaction requires some type of operation by enterprise 106 and enterprise 104 transfers an assertion to enterprise 106, then enterprise 104 is the issuing domain with respect to the particular operation, and enterprise 106 is the relying domain for the operation; in other words, enterprise 106 is the service provider for the current transaction. Assuming the transaction requires further operations such that enterprise 106 transfers an assertion to enterprise 108, then enterprise 106 is the issuing domain with respect to the requested operation, and enterprise 108 is the relying domain for the operation; in this case, enterprise 108 may be regarded as another downstream service provider, although a federated transaction can usually be described as involving only two domains, the identity provider and the service provider.

In a federated space, the problem of managing a lifecycle of a user's session is complex. One solution to this problem is described in the above-identified patent application. In particular, and with reference now to FIG. 2, a block diagram depicts some of the components in a federated domain for implementing federated user lifecycle management functionality in accordance with the prior art. FIG. 2 depicts elements at a single federated domain, namely, a point-of-contact server/service 202, application servers 204, i.e. resource controlling services, protected or controlled resources 206, and a federated user lifecycle management (FULM) application 208. Firewall 210 and firewall 212 create an external DMZ that protects the enterprise's computing environment from computing threats outside of the enterprise's domain, e.g., via the Internet. The point-of-contact entity provides session management, at least with respect to a user's interaction with the federation functionality with an enterprise's computing environment; an application within a legacy back-end of the enterprise's computing environment may also implement its own session management functionality. Assuming that an enterprise implements policy functionality with respect to the federated computing environment, the point-of-contact entity may act as a policy enforcement point to some other federation partner's policy decision point. In addition, assuming that it is permissible given the implementation of the federation functionality, the point-of-contact entity is responsible for initiating a direction authentication operation against a user in those scenarios in which a single-sign-on operation is not employed. As such, the point-of-contact entity may be implemented in a variety of forms, e.g., as a reverse proxy server, as a web server plug-in, or in some other manner. The point-of-contact functionality may also be implemented within an application server itself, in which case the federated user lifecycle management services may be located within the DMZ.

In the prior art, federated user lifecycle management application 208 comprises support for interfacing to, interacting with, or otherwise interoperating with, federated user lifecycle management plug-ins 214. The federated protocol runtime plug-ins provide the functionality for various types of independently published or developed federated user lifecycle management standards or profiles, such as: WS-Federation Passive Client; Liberty Alliance ID-FF Single Sign On (B/A, B/P and LECP); Register Name Identifier; Federation Termination Notification; and Single Logout (SLO). Different sets of federated protocols may be accessed at different Uniform Resource Identifiers. This approach allows the federated user lifecycle management application to concurrently support multiple standards or specifications of federated user lifecycle management, e.g., the WS-Federation web services specification versus the Liberty Alliance's specifications, within a single application, thereby minimizing the configuration impact on the overall environment for supporting different federation protocols.

The appropriate federated user lifecycle management functionality is invoked by the point-of-contact server by redirecting and/or forwarding user requests to the federated user lifecycle management application as appropriate. Referring again to FIG. 2, point-of-contact server 202 receives user requests 220, which are then analyzed to determine the type of request that has been received, which might be indicated by the type of request message that has been received or, as noted above, by determining the destination URI within the request message. While requests 222 for protected resources continue to be forwarded to application servers 204, requests 224 for federated user lifecycle management functions, e.g., a request to invoke a single-sign-off operation, are forwarded to federated user lifecycle management application 208, which invokes the appropriate federated user lifecycle management plug-in as necessary to fulfill the received request. When a new federation protocol or a new federated function is defined, or when an existing one is somehow modified or refined, support can be added simply by plugging a new support module or can be refined by modifying a previously installed plug-in.

Thus, to facilitate session management, current solutions provide internal plug-ins that are specific for a given SSO protocol (SSOp) or a given point of contact (POC). The requirement for specialized plug-ins increases the complexity of the overall system, and it reduces scalability and reliability. Moreover, when the entity managing the authentication determines that the session should be destroyed, it typically does so by making a call across an authentication-specific application programming interface (API). This API may be serialized and, thus, it presents a potential single-point-of-failure.

### BRIEF SUMMARY OF THE INVENTION

The present invention is implemented in a method operative within a federated environment in which a point of contact serves as an intermediary between a client browser and an authentication service. According to a first step, the method provides an external authentication interface through which the authentication service authenticates a user associated with the client browser using information communicated in a first HTTP request-response exchange. That external authentication interface is then extended to enable the point of contact to terminate the user session using information passed in a second HTTP request-response exchange. The authentication service may be an identity provider that provides identity management in the federated environment.

Another embodiment of the invention is provided in a method that operative within a federated environment comprising at least one identity provider, and one service provider, and wherein a point of contact serves as an intermediary between a client browser and the identity provider. The method begins by issuing a first request to the identity provider using a first HTTP request-response exchange, wherein a response header associated with the first HTTP request-response exchange includes a session identifier. The session identifier is then used to create a user session. Subsequently (i.e., when it is desired to log out), a second request is issued to the identity provider using a second HTTP request-response exchange, and the HTTP response is received at the point of contact. A response header associated with the second HTTP request-response exchange includes the session identifier. Based on the HTTP response header having the associated session identifier, the POC destroys the user session.

The present invention provides a generic technique that externalizes the management of a user session, particularly in the context of a federated environment. The invention obviates any requirement to design and implement special software (or any requirement to modify a previously installed plug-in) to enable third party SSOp-aware applications to manage the lifecycle of a user session. In an illustrative embodiment, the user session lifecycle is managed externally through an external authentication interface (EAI) that has been extended to enable any POC (or SSOp-aware application) to interface to a federated identity provider component using a simple HTTP transport mechanism. In the inventive approach, HTTP request and response headers carry the information that is used by the POC to initiate and later destroy a user session, and such information is provided by a federated entity without requiring use of a special authentication API.

The foregoing has outlined some of the more pertinent features of the invention. These features should be construed to be merely illustrative. Many other beneficial results can be attained by applying the disclosed invention in a different manner or by modifying the invention as will be described.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 depicts a federated heterogeneous environment;

FIG. 2 depicts a prior art scheme for user lifecycle management for a federated environment;

FIG. 3 illustrates an access management framework for use in a Web portal;

FIG. 4 illustrates the inventive technique for external user lifecycle management for a federated environment;

FIG. 5 illustrates an external authentication interface (EAI) authentication that is used to create a user session; and

FIG. 6 illustrates how the extended EAI is used to terminate the user session created in FIG. 5.

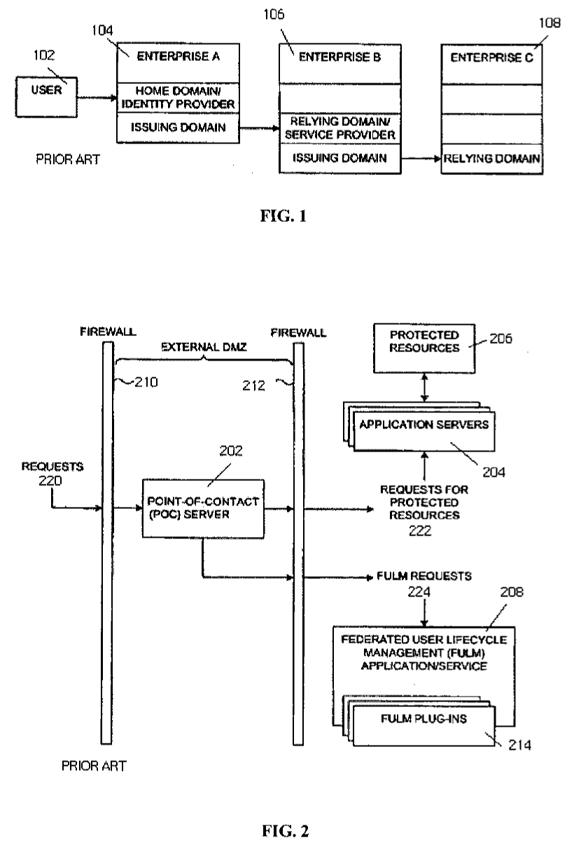

### DETAILED DESCRIPTION OF AN ILLUSTRATIVE EMBODIMENT

Generally, the present invention may operate in conjunction within the standard client-server paradigm in which client machines communicate with an Internet-accessible Web-based portal (or, more generally, target server or site) executing on a set of one or more machines. End users operate Internet-connectable devices (e.g., desktop computers, notebook computers, Internet-enabled mobile devices, cell phones having rendering engines, or the like) that are capable of accessing and interacting with the destination. Typically, each client or server machine is a data processing system comprising hardware and software, and these entities communicate with one another over a network, such as the Internet, an intranet, an extranet, a private network, or any other communications medium or link. As described below, a data processing system typically include one or more processors, an operating system, one or more applications, and one or more utilities. The applications on the data processing system provide native support for Web services including, without limitation, support for HTTP, SOAP, XML, WSDL, UDDI, and WSFL, among others. Information regarding SOAP, WSDL, UDDI and WSFL is available from the World Wide Web Consortium (W3C), which is responsible for developing and maintaining these standards; further information regarding HTTP and XML is available from Internet Engineering Task Force (IETF). Familiarity with these standards is presumed in the following discussion.

As will be described, the present invention typically is implemented in a system that includes an access manager, which is a component that prevents unauthorized use of resources, including the prevention of use of a given resource in an unauthorized manner. A representative access manager is the Tivoli® Access Manager product, which is available commercially from IBM. Of course, the identification of this commercial product is merely for purposes of explanation, and it is not meant to be taken to limit the present invention. More broadly, any system, device, program or process that provides a policy/access/service decision may be used for this purpose.

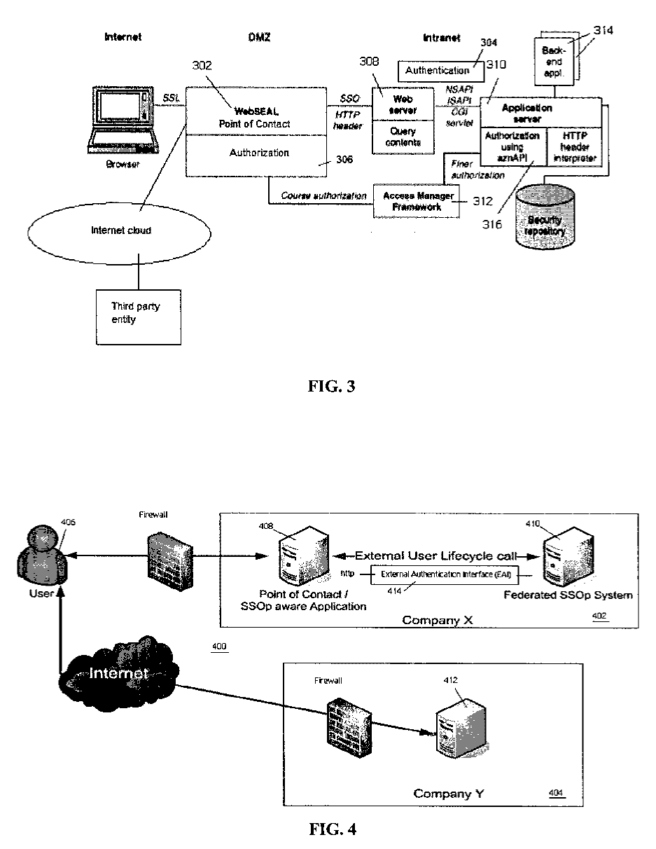

By way of additional background, FIG. 3 illustrates how an access manager is integrated into a Web portal to provide authorization and access control services for Web resources. A high performance, multi-threaded Web server 302 (e.g., IBM WebSEAL), an access manager component, is a “point of contact” (POC) that manages access to all Web servers (such as Web server 308), regardless of their platforms. This allows the enterprise to centrally control their Web resources as a single, logical Web space. When users first enter a portal, they are prompted to provide authentication information that allows the portal to verify the identity of the user. Authentication typically is based around login (e.g., user name and password), a single sign-on protocol, or the like. An authentication mechanism 304 provides this function. In particular, in response to an authentication request received from the POC, the authentication mechanism 304 determines whether authentication is appropriate and, if so, returns to the POC a credential, or an identity (which is used by the POC to build a credential). The POC binds the credential to the user session. The POC typically maintains a session cache that can be represented as an internal table where the process stores information about all sessions established by authenticated users. A session key, stored with the client, is a locator index to the associated session data stored in the session cache. Each user session is represented by an entry in the cache table. Each cache entry contains the following types of information: the session key, cache data, and timestamps. The session key (or session ID) is a unique identifier that is sent with each request made by that user. The session key identifies the specific cache entry for that user. The cache data includes the user credential, which typically is an encoded opaque data structure representing the authenticated user. The credential contents can include user name, group memberships, and extended attributes (that allow storage of customized data). The credential is required whenever the user requests protected resources. An authorization service (described below) uses the credential information to permit or deny access to the resource. The timestamps include a creation timestamp, which entry becomes the reference point for the session lifetime value. A “last active” timestamp for the cache entry becomes the reference point for a session inactivity timer. Upon creation of the user session, the session cache is populated, which initiates the session lifecycle. The lifecycle ends when the user's session is removed from the session cache, which may occur upon receipt of an explicit log out command (from a log out mechanism), or for reasons unknown to the user (such as session timeout, session displacement, or session termination).

The authentication mechanism 304 typically executes in Web server 308, although this is not a requirement as this function may be carried out by a application server 310.

Authorization, in contrast to authentication, determines what resources an authenticated client can use. For example, a customer may only be able to access e-business applications from the Internet, whereas an employee might also be permitted to access corporate applications. An authorization mechanism 306 provides this function. The Web server component 302 also provides a single sign-on, coarse-grained access control (namely, whether one can access the Web server 308 or not), high availability, and scalability. As shown in FIG. 3, the access manager also enables access control for individual objects on the Web server 308 or application server 310. This maybe accomplished by placing a custom common gateway interface (CGI) script on the Web server. This script allows a management console to display and manage the Web space, or application space, of the Web and application servers. Preferably, the access manager framework 312 handles access control for static content and dynamic content. In particular, a utility may be used to place access control lists (ACLs) in components of applications, or in CGIs. By passing user and group information in HTTP headers, the application server 310 can make further access control decisions if required. The information passed from the POC can also be used to access back end applications 314. In addition, for more fine-level authorization control, the access manager implements aznAPI 316, which is an Open Group standard that allows an application to call out to an authorization service for authorization decisions. In this case, access manager identity information passed to the application server by an HTTP header can be used by aznAPI to make further fine-grained access control decisions, e.g., based on the specific internals of the application (and any authorization decisions enforced by the POC component 302). Information passed from the POC and obtained from the access manager framework 312 can be used to make access decisions to back end applications.

With the above as background, the present invention is now illustrated and described. As mentioned previously, preferably the invention is implemented within a federated identity management (FIM) scenario, wherein typically different organizations assume the role of an identity provider or a service provider. These roles are not necessarily mutually exclusive. An identity provider is an organization that directly manages end users. It acts as the authoritative source for issuing and validating user identities and network credentials for a set of users; thus, an identity provider “owns the user relationship.” For example, many companies act as identity providers for employees, customers, and contractors. Identity providers “vouch” for the user identity and their entitlements in a federated interaction with service providers. The “identity provider” role can be thought of as an authentication authority. A service provider provides “services” for end users. A service provider typically does not have a vested business interest in managing the user. Thus, service providers act as a “relying party” to validate credentials issued by a trusted identity partner, on the basis of which they provide services to that trusted identity. A federated model simplifies administration and enables companies to extend identity and access management to third-party users and third-party services.

FIG. 4 illustrates the federated identity management (FIM) environment 400 wherein there are two distinct entities, Company X 402, and Company Y 404. Of course, a federated environment may include any number of entities or organizations. User (or, more specifically, the user's browser) 406 accesses Company X through a point of contact 408, such as was described above in FIG. 3. The point of contact 408 typically executes at least one SSOp-aware application, such as the access manager previously described. That application has the capability of communicating with federated SSOp system 410. An example of such a system is the Tivoli® Federated Identity Manager product, which is available commercially from IBM. The system 410 and, in particular, the FIM functionality, has the capability of serving as an identity provider (to facilitate, among other services, authentication), or as a service provider. Company Y 404 is a participant in the federation and typically operates its own computing entities, such as system 412. In a typical case, Company Y's system 412 operates as a service provider within the context of the federated scheme.

The “lifecycle” of a user's session extends from the time of first authenticating the user (e.g., via log in, single-sign in, or the like) until the session is subsequently destroyed, either due to a lack of activity on the system, or by a voluntary user action (e.g., via log out, sign out or the like). Thus, in one embodiment, a user session lifecycle persists for the time period during which a POC session cache maintains a cache entry (or at least a valid one) about that session. As noted above, a user session is established by building a credential for the user based on authentication data, and then binding the user to the credential. According to a feature of the present invention, the user session lifecycle is “externalized” by extending an external authentication interface (EAI) 414, which is used to create the session, to allow the identity provider 410 (or some other entity) to force the POC 408 to terminate a session that the POC created. As will be seen, the external authentication interface takes advantage of simple HTTP header requests and responses to enable third party POC- and SSOp-aware applications to manage the lifecycle, namely, to create the user session, and then, as required, to destroy it.

An external authentication interface (such as the interface provided by Tivoli Access Manager) allows an independent remote service, such as a federated identity provider, to handle the authentication process for the POC (e.g., a proxy, a Web server plug-in, or the like). The identity information returned by the external authentication interface service is used to generate user credentials, as has been previously described. Typically, the external authentication interface returns user identity information in HTTP response headers rather than through an authentication module interface or other API. As described in more detail below, this existing mechanism is extended according to the present invention to fully externalize the creation and destruction of the user session.

The external authentication interface is not a replacement for built-in or custom authentication modules. Rather, the external authentication interface provides a convenient and flexible authentication capability for many environments. Thus, for example, the external authentication interface can be used with applications written in any language, including Java. Using the external authentication interface, the authentication operation is performed external to the POC (or its SSOp-aware application), e.g., by an application or component located on a remote, junctioned server. This application or component should return identity information resulting from the authentication process, preferably in HTTP response headers as will be described.

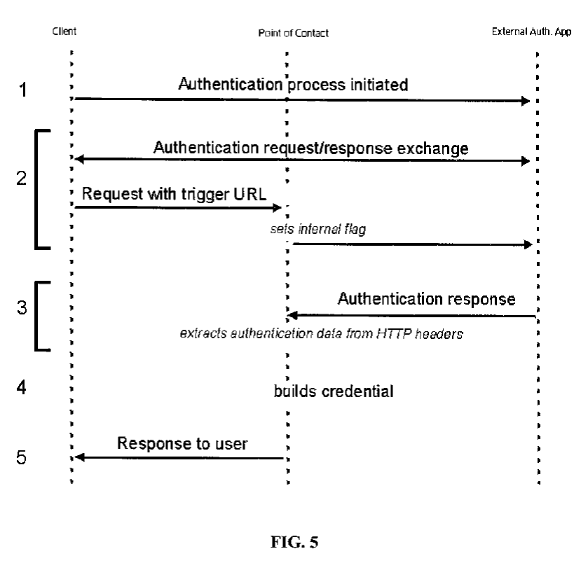

FIG. 5 illustrates the process flow for external authentication interface authentication. This process creates the user session lifecycle, and a parallel process (as will be seen) is used to terminate (destroy) it. The components of this example process flow scenario include the client browser 500, the POC (such as the WebSEAL, a Web server plug-in, or the like) 502, and a junctioned server 504 on which an external authentication application (that uses the external authentication interface) executes. The authentication process is initiated at step 1. There are many possibilities for initiating the authentication process. A typical example is when an unauthenticated user requests a protected resource. At this point, the POC 502 intercepts the request and returns a redirect, e.g., to a customized login.html response page. The login.html page typically is customized to contain a submit link to the external authentication application. The user provides log in information (e.g., user name and password) on the form and clicks the submit link to send the data to the external authentication application. Other examples of initiating the authentication process include manually typing an appropriate link to the external authentication application, performing a single sign on, or, as in a federated identity management scenario, the user is redirected to the external authentication application from a service provider, with the goal of having an identity provided for that user.

Step 2 is the authentication request and response exchange. The process of authentication may require a number of exchanges between the external authentication application and the client. Preferably, exchanges are streamed through (not intercepted) by the POC. The final authenticating request to the external authentication application typically is directed to a distinct URL. This URL, for example, could include a query string that indicates a log in task. Typically, the final URL is specified in a configuration file as a trigger URL. If the trigger URL is detected, the POC examines the corresponding response for authentication data located in HTTP headers (specified in a POC configuration file). By way of example, the user clicks a submit link on a custom log in page. This link is the trigger URL. The recognition of the trigger URL in the request causes the POC to look for authentication data in the corresponding response. The external authentication application authenticates the user and, in its response, populates the HTTP headers with authentication data. In another example, it is assumed that the external authentication application requires several exchanges with the user to receive the required login information. In such case, each request to the external authentication application uses the trigger URL. For each response, POC looks for authentication data. In particular, POC examines each corresponding response for authentication data returned from the external authentication interface in HTTP headers. When no authentication takes place, these headers are empty in each response. POC continues streaming the requests and responses without taking any action. After several exchanges, the external authentication application is presumed to receive the log in information it needs. The external authentication application authenticates the user and, in its final response, populates the HTTP headers with authentication data. In yet another example, it is assumed that the external authentication application requires several exchanges with the user to receive the required log in information. Each request to the external authentication application uses a URL that does not match the trigger URL. Therefore, for each corresponding response, the POC does not look for authentication data. The POC streams the requests and responses without taking any action. The final request to the external authentication application, however, uses the trigger URL. The recognition of the trigger URL in this final request causes the POC to look for authentication data in the corresponding response. The external authentication application authenticates the user and, in its final response, populates the HTTP headers with authentication data.

Step 3 is the authentication response. Here, the POC examines the corresponding response and finds the authentication data in the HTTP headers. At step 4, the POC uses the authentication data to build a credential for the user. Then, at step 5, the POC sends a response to the user, typically with the following precedence: if automatic redirection is enabled, the user is redirected to the location specified in a POC configuration file; if the initial request was cached, the request is reprocessed for the user; if the response from the external authentication application contains a redirection URL header, the user is redirected to the location specified by that URL; otherwise, the POC responds with a log in success page. This completes the process of initiating the user session lifecycle (which, as noted above, creates the session cache entry).

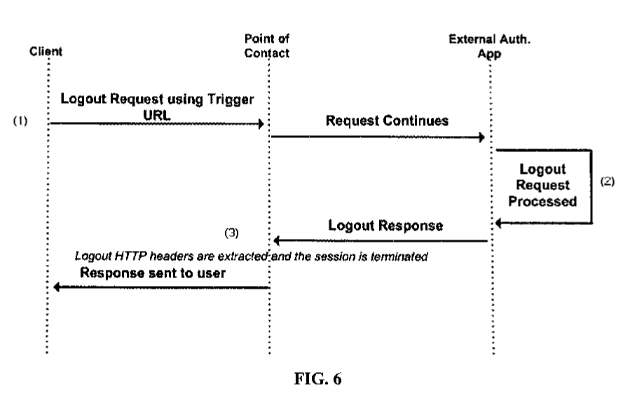

FIG. 6 illustrates the process flow for log out through the external authentication interface. In step 1, the client (which may be on behalf of an entity in the federation) initiates a log out request to the POC using the trigger URL. The request continues through to the external authentication application, where it is processed in step 2. When complete, the external authentication application sends a log out response. At step 3, and as will be described in more detail below, the POC extracts the log out HTTP headers and the user session is terminated, with the response then being returned to the client.

As also noted above, given HTTP headers preferably contain the authentication data returned from the external authentication application. These headers may be specially named, although this is not a requirement. There may be several categories of HTTP headers used to hold authentication data. For example, a Privilege Attribute Certificate (PAC)-named header may be used PAC is an ASN.1 data structure used to express identity information. Authentication data returned to the POC in PAC format can be directly converted to a credential. Another category is a user identity-named header. When the user identity format type is used, the information is processed by the authentication module and a credential is built by the access manager authorization API. The special HTTP headers contain authentication data provided by the external authentication application. The presence of either the PAC header or the user identity header causes the POC to extract the authentication data from the headers and build a credential for the user.

According to the present invention, the above-described external authentication interface is extended to allow the FIM (or other authentication entity) to make a log out (or sign out) call to the POC. This extension enables the POC (the calling entity) to terminate the session that it created. In a preferred embodiment, the call also is accomplished using the same HTTP request and response protocol described above in connection with the log in scenario. In this manner, it can be seen that the external authentication interface 414 now provides control over both the creation of a user session, as well as the termination of that session, in effect providing the externalized lifecycle management that is an object of the present invention. This operation provides significant advantages over the prior art. As one of ordinary skill in the art will appreciate, by extending the EAI to facilitate HTTP-header based operations (log in, sign in, log out and sign out), the inventive method provides a generic technique that externalizes the management of a user session so that third party SSOp-aware applications can easily manage the session's lifecycle. Externalizing the user session lifecycle moves specific POC implementation details away from the SSOp application, to the POC that is better able to manage the session. This has the advantage of decreasing product development time and increases the flexibility of the system to handle more POC types.

HTTP uses the known client-server model wherein an HTTP client opens a connection and sends a request message to an HTTP server; the server then returns a response message, which usually contains the resource that was requested. The format of the request and response messages are similar and each typically comprises an initial line, zero or more header lines (each with a value), a blank line, and an optional message body. Header lines provide information about the request or response, or about the object sent in the message body. The header lines are in a text format, typically one line per header, of the form “header-name: value”, ending with one or more control characters. HTTP headers are extensible to include additional information.

In one embodiment, an EAI lifecycle header has the following general format: {header-name: action|name1=value1; name2=value 2, name3=value 3, and so on for other extended attributes}. The “action” attribute may not be required if the type of action is identified by the header name itself. For example, a log in action may use header-name EaiLogin, and the log out action may use header-name EaiLogout. Because the type of action is defined by the name, there is no need for an explicit “action” attribute, for example, describing “log in” or “log out.” In some circumstances it may be desirable to use existing header names, in which case the action attribute may be used to describe the particular function. The request and response header values will depend on the action being taken. For example, for log in, the HTTP request header may include values designating user credential details (such as group membership, attributes, or the like), as well as an optional SSOp message (that may include one or more user attributes or other information that an SSOp component may require). The HTTP response header values also will depend on the action being taken. Typically, the response header values describe the action that was fulfilled by the request (e.g. log in, log out), and provide other information and data, such as server-specific details, user identifier details, and session identifier details. Thus, for example, the following is the HTTP response header returned to the POC from an FIM component after it (the FIM) has initiated a log out:

EaiLogout: userid=jon.doe; sessionid=68B86DFF8E4A8597B210531C3431965D

This HTTP response header terminates the session by deleting the session identifier entry from the session cache. As noted above, this action terminates the user session lifecycle, under external control.

There may be multiple HTTP request-response exchanges across the extended EAI to facilitate management of the user session lifecycle.

Moreover, while the above described uses HTTP as the underlying transport protocol, other request-response transport protocols, such as HTTPS, may be used as well.

The present invention is not limited to a Web-based portal having a point of contact that provides authentication, session management and authorization, but this will be a typical implementation. The invention may be used in any system, device, portal, site, or the like.

More generally, the invention can take the form of an entirely hardware embodiment, an entirely software embodiment or an embodiment containing both hardware and software elements. In a preferred embodiment, the invention (comprising the client side functionality, the server side functionality, or both) is implemented in software, which includes but is not limited to firmware, resident software, microcode, and the like. Furthermore, as noted above, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

One or more of the above-described functions may also be implemented as a service in a hosted manner.

While the above describes a particular order of operations performed by certain embodiments of the invention, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

Finally, while given components of the system have been described separately, one of ordinary skill will appreciate that some of the functions may be combined or shared in given instructions, program sequences, code portions, and the like.

Having described our invention, what we now claim is as follows.

1. A method, operative within a federated environment in which a point of contact serves as an intermediary between a client browser and an authentication service, comprising:
providing an external authentication interface through which the authentication service authenticates a user associated with the client browser using information communicated in a first HTTP request-response exchange; and
extending the external authentication interface to enable the point of contact to terminate the user session using information passed in a second HTTP request-response exchange.

2. The method as described in claim 1 wherein the authentication service is an authentication service that is independent from the point of contact.

3. The method as described in claim 2 wherein the authentication service is an identity provider that provides identity management in the federated environment.

4. The method as described in claim 1 wherein the first HTTP request-response exchange comprises a request having a header, the header including a name, and at least one value.

5. The method as described in claim 4 wherein the name is associated with a first user session lifecycle operation.

6. The method as described in claim 5 wherein the first user session lifecycle operation is a log in or a sign on.

7. The method as described in claim 6 wherein the sign on is a federated single sign on.

8. The method as described in claim 1 wherein the second HTTP request-response exchange comprises a request having a header, the header including a name, and at least one value.

9. The method as described in claim 8 wherein the name is associated with a second user session lifecycle operation.

10. The method as described in claim 9 wherein the second user session lifecycle operation is a log out or single sign out.

11. The method as described in claim 10 wherein the sign out is a federated single sign out.

12. The method as described in claim 1 wherein the point of contact is one of: a proxy, and a web server plug-in.

13. A computer-readable medium having computer-executable instructions for performing the method steps of claim 1.

14. Apparatus comprising a processor, and a computer-readable medium, the computer-readable medium having processor-executable instructions for performing the method steps of claim 1.

15. A method, operative in a federated environment comprising at least one identity provider, and one service provider, wherein a point of contact serves as an intermediary between a client browser and the identity provider, comprising:
providing an external authentication interface through which the identity provider authenticates a user associated with the client browser using information communicated between the point of contact and the identity provider in a first request-response exchange; and
extending the external authentication interface to enable the point of contact to terminate the user session using information passed in a second request-response exchange.

16. The method as described in claim 15 wherein at least the first or the second request-response exchange is an HTTP request-response exchange.

17. A method, operative within a federated environment comprising at least one identity provider, and one service provider, and wherein a point of contact serves as an intermediary between a client browser and the identity provider, comprising:
issuing a first request to the identity provider using a first HTTP request-response exchange, wherein a response header associated with the first HTTP request-response exchange includes a session identifier;
using the session identifier to create a user session;
issuing a second request to the identity provider using a second HTTP request-response exchange, wherein a response header associated with the second HTTP request-response exchange includes the session identifier;
based on the session identifier, destroying the user session.

18. The method as described in claim 17 wherein the first request is one of: a log in or sign in.

19. The method as described in claim 17 wherein the second request is one of: a log out or sign out.

20. The method as described in claim 17 wherein the user session is created by populating a point of contact session cache with an entry associated with the session identifier.

21. The method as described in claim 20 wherein the step of destroying the user session includes deleting the entry in the point of contact session cache.

22. Apparatus, comprising:
a component that serves as an intermediary between a client browser and one or more back end applications; and
a computer readable medium having program code executable by a processor to perform the following method steps:
issuing a first request to the identity provider using a first HTTP request-response exchange, wherein a response header associated with the first HTTP request-response exchange includes a session identifier;
using the session identifier to create a user session;
issuing a second request to the identity provider using a second HTTP request-response exchange, wherein a response header associated with the second HTTP request-response exchange includes the session identifier;
based on the session identifier, destroying the user session; and

23. The apparatus as described in claim 22 wherein the component performs an authentication function.

24. The apparatus as described in claim 22 wherein the component performs an authorization function.

25. The apparatus as described in claim 22 wherein the program code executes in a reverse proxy.

26. The apparatus as described in claim 22 wherein the program code executes in a server plug-in.
